(19) United States
(12) Patent Application Publication
(10) Pub. No.: US 2003/0012343 A1
(43) Pub. Date: Jan. 16, 2003

(54) Method and device for call-waiting signal to identify tolerant errors

(76) Inventors: Michael Mou, Tu-Cheng City (TW); Cheng-Jen Lin, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/900,868

(22) Filed: Jul. 10, 2001

(51) Int. Cl. H04M 1/24; H04M 3/22

(52) U.S. Cl. 379/32.04; 379/22.02; 379/27.03; 379/29.05; 379/1.01

(57) ABSTRACT

The present invention is related to a method and device for call-waiting signal to identify tolerant errors and particularly to a method and device for call-waiting signal on a telephone set with a call-waiting function to identify tolerant errors though making use of an amplitude detecting device to perform a reaffirming action so as to escalate the identification rate of the call-waiting signal..

### BACKGROUND OF THE INVENTION

1. Field of the Invention

The present invention is related to a method and device for call-waiting signal to identify tolerant errors and particularly to a method and device for call-waiting signal to identify tolerant errors on a telephone set with a call-waiting function.

2. Description of the Prior Art

As shown in FIG. 1 which is an optional view of a telephone set connected to a switchboard end, when telephone A and telephone B are proceeding with talking but telephone C intends dialing to telephone A for talking, the switchboard end will transmit a call-waiting dignal to telephone A. According to the practice in Taiwan, the call-waiting signal is an audio signal to notify the user of telephone A that the telephone of third party intends to proceeding with talking, and the said user may use the function key on the keyboard (normally it is a flash key) to proceed with the cut-over of talking status between telephone A and telephone B or C. However, such a sustained audio signal seriously affects the original talking quality between telephones A and B, and the users at two ends of telephones A and B are difficult to identify where the call-waiting signal comes from. Therefore, a considerable large disturbance is resulted.

In the more advanced countries such as the United States of America in the aspect of telecommunications business, a different practice is adopted, the call-waiting signal is a compound audio signal coinciding with a specific time length and a frenquency specification (2130 Hz/2750 Hz of a time length 80 ms (microsecond)). Such a signal with a rather weak amplitude strength is difficult to be found by the user and thus does not affect the talking quality between telephones A and B. When the tone detector 11 of telephone A detects such a call-waiting signal on the signal line 10 (please refer to FIG. 2 which is an optional view of function blocks), a microcontroller 12 is triggered at once to cut off the action of telephone A transmitting the audio signal received from outside to the said signal line for a specific time (normally it is set at one second), to wit, to stop transmitting the audio signal received by the hand set of telephone to the signal line for one second, and at the same time, the switchboard end will not transmit the audio signal from telephone B to the signal line of telephone A within one second. Such being the case, any foreign voice will be no more transmitted to the said signal line within such one second, but the switchboard makes use of such one second to transmit the telephone number of telephone C (normally to make use of the rear section of such one second for tramsmission) to the display screen 13 of telephone A for display so as to remind the user of telephone A that there is a call-waiting from the third party, and telephones A and B restore their talking after one second, then telephone A and B still can continue talking, and their talking quality will not be disturbed by the call-waiting signal any more, the user of telephone A can decide whether to stop talking to telephone B and cut over to telephone C for talking in line with the telephone number displayed on the display screen 13, such an operation also has a function of filtering telephone.

The foregoing call-waiting signal transmitted from the switchboard end after conveyance by the signal line is very possible to generate attenuation or mix noise so as to deform the originally transmitted call-waiting signal. Therefore we must have a tolerant zone of specification errors (namely, the first specific time zone which normally is 30 ms to 90 ms.) to collate the specification of call-waiting signal because strictly collating with the time length 80 ms will considerably lower the accurate reception rate to an intolerable extent but on the contrary, too large tolerant error zone will largely increase the probability of error action, and the most usual status is that the audio signal from the user of telephone B or the background voice in the position of telephone B just has an audio signal coinciding with the tolerant zone of specification errors (compound audio signal of 2130 Hz/2750 Hz), and at the same time, the tone detector 11 of telephone A will mistakenly judge it as an incoming call-waiting signal and trigger the microcontroller 12 to generate a series of error actions such as the action of generating a voice interruption for one second so as to be ready receiving a signal representing the telephone number of the third party (but in fact no transmission of a signal representing the telephone number of the third party) and this action will disturb the user. How to improve the drawbacks of the foregoing conventional techniques is the primary object of the present invention.

### SUMMARY OF THE INVENTION

The present invention is a method for call-waiting signal to identify tolerant errors and applied to a telephone set with a call-waiting function, the telephone set electrically connected to a switchboard end through a signal line wherein the steps include: (a) To detect the signal line: when it is detected that the time length of signal is in a first specific time zone and coinciding with a specfic freluency specification, a trigger signal is transmitted; (b) In response to the trigger signal: to interrupt the action of telephone set transmitting the voice signal received from outside to the signal line and continue detecting the signal on the signal line up to a second specific time; and (C) When the signal amplitude strength on the signal line is detected as larger than a specific value in the second specific time, to restore the action of telephone set transmitting the voice signal received from outside to the signal line.

On the other hand, the present invention is a device for call-waiting signal to identify tolerant errors and applied to a telephone set with a call-waiting function, the telephone set is electrically connected to a switchboard end through a signal line wherein the identification device includes: a tone detector which is electrically connected to the signal line and designed to detect the signal line and transmits a trigger signal when the time length of detected signal is in a first specific time zone and coinciding with a specific freqnuency specification; a microcontroller which is electrically connected to the tone detector and in response to the triggering of the trigger signal to interrupt the action of the telephone set transmitting the voice signal received from outside to the signal line and to transmit a reaffirming signal; and an amplitude detecting device which is electrically connected to the signal line and microcontroller and in response to the triggering of the reffirming signal to continue detecting the signal on the signal line for a second specific time, and when the signal amplitude strength on the signal line is detected as larger than a specific value in the second specific time, a restoring signal is transmitted to trigger the microcontroller for restoring the action of the telephone set transmitting the voice signal received from outside to the signal line.

The present invention can judge the signal received as the voice signal from the telephone user of the talking party or the background voice in the position of the telephone set but not the call-waiting signal really transmitted from the switchboard end, so a series of error actions resulted from mistaken triggering the microcontroller 12 can be avoided to thoroughly improve the drawbacks of conventional means.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numberals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an optional view of three telephone sets connected to a switchboard.

FIG. 2 is an optional block diagram of the functions of a conventional telephone set with a call-waiting function.

FIG. 3 is an optional block diagram of the function of a preferred embodiment according to the present invention.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

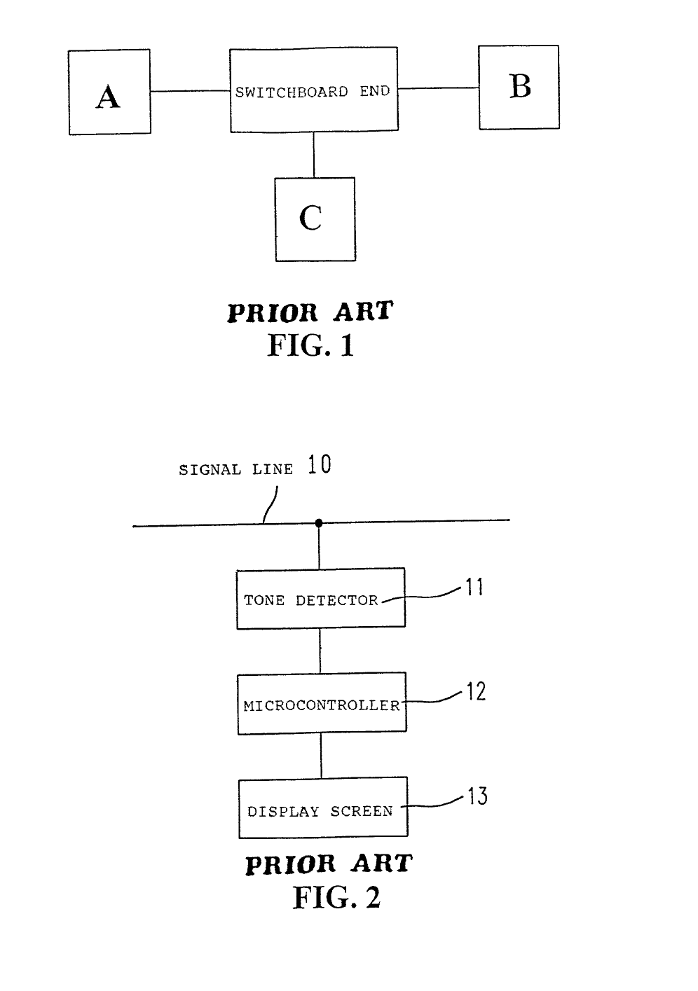

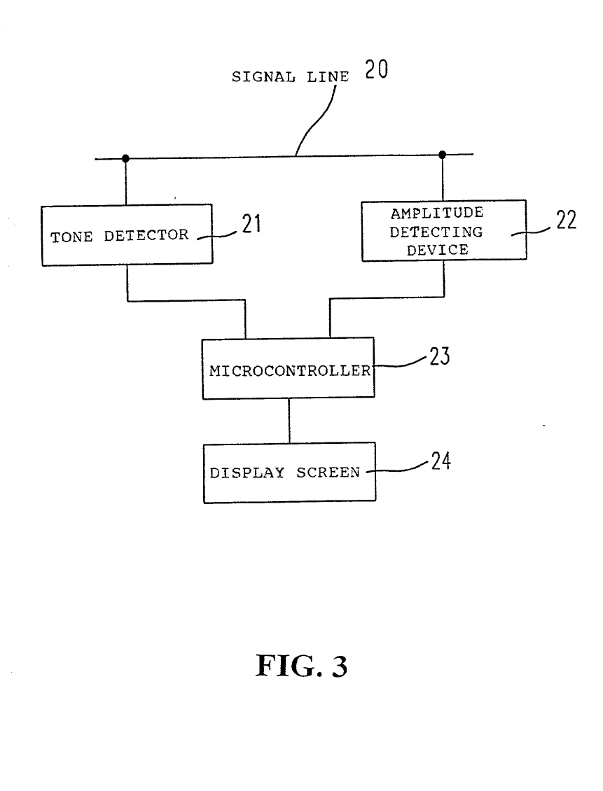

As show in FIG. 3, the present invention consists of a tone detector 21, an amplitude detecting device 22 and a microcontroller 23. We set the framework of three telephone sets as shown in FIG. 1 as an example to describe the technical means concerned. When the tone detector 21 of telephone A detects the times length of a signal on the signal line 20 coinciding with the tolerant zone of specification errors (namely, the first specific time zone which noramlly is 30 ms to 90 ms), a trigger signal is transmitted at once to trigger the microcontroller 23 for interrupting the action of the telephone A transmitting the voice signal received from outside to the signal line (namely, to stop transmitting the voice signal received by the hand set of telephone A to the signal line) and a reaffirming signal is transmitted to the amplitude detecting device 22. In response to the triggering of the reaffirming signal, the amplitude detecting device 22 continues to detect the signal on the signal line for a second specific time (approximately 10 ms) and amplify and detect whether the amplitude strength of the signal received in the said 10 ms is larger than a specific value or not. When the switchboard end really transmits a call-waiting signal, the switchboard end will not transmit the voice signal of telephone B to the signal line of telephone A in the specific time (normally one seoncd) in order to not disturb transmitting the telephone number signal of telephone C. Therefore if the switchboard end really transmits a call-waiting signal, the signal received by the amplitude detecting device 22 in the 10 ms will be close to zero and not larger than a preset specific value so as to judge the real call-waiting signal and continue the follow-up action of waiting for transmitting the telephone number of telephone C. However, if the signal of trigger signal transmitted by tone detector 21 is the voice signal transmitted by the user of telephone B or the background signal in the position of telephone B but not the call-waiting signal really transmitted by the switchboard end, the action of transmitting the voice signal of telephone B to the signal line of telephone A will not stop. So after the signal received by the amplitude detecting device 22 in the 10 ms is amplified and detected, the amplitude strength of the said signal is surely larger than the specific value, and at the same time, the amplitude detecting device 22 transmits a restoring signal to trigger the microcontroller for restoring the action of telephone set transmitting the voice signal received from outside to the signal line and stopping preparation for receiving the telephone number signal representing the third party so as to avoid mistakenly triggering the microcontroller 12 from generating a series of error actions and thoroughly improve the drawbacks of conventional means.

In view of the above, the present invention can judge the signal received as the voice signal of telephone user from the talking party or the background voice in the position of the telephone set but not the call-waiting signal really transmitted from the switchboard end so as to avoid a series of error actions from disturbing the user and thoroughly improve the drawbacks of conventional means. The present invention may be modified by those who skilled in this art but all the modifications thereby should never be alien to the spirit of claims of the present invention.

I claim:

1. A method for call-waiting signal to identify tolerant errors which is applied to a telephone set with a calling-waiting function, this telephone set is electrically connected to a switchboard end through a through a signal line, wherein the steps include:
(a) to detect the signal line: when it is detected that the time length of signal is in a first specific time zone and coinciding with a specific frequency specification, a trigger signal is transmitted;
(b) in response to the trigger signal: to interrupt the action of telephone set transmitting the voice signal received from outside to the signal line and continue detecting the signal on the signal line up to a second specific time; and
(c) when the signal amplitude strength on the signal line is detected as larger than a specific value in the second specific time, to restore the action of telephone set transmitting the voice signal received from outside to the signal line.

2. A device for call-waiting signal to identify tolerant errors which is applied to a telephone set with a call-waiting function, this telephone set is electrically connected to a switchboard end through a signal line, wherein the identification device includes:
a tone detector which is electrically connected to the signal line and designed to detect the signal line and transmits a trigger signal when the time length of detected signal is in a first specific zone and coinciding with a specific frequency specification;
a microcontroller which is electrically connected to the tone detector and in response to triggering of the trigger signal to interrupt the action of the telephone set transmitting the voice signal received from outside to the signal line and to transmit a reaffirming signal; and
an amplitude dectecting device which is electrically connected to the signal line and microcontroller and in response to the triggering of the reaffirming signal to continue detecting the signal on the signal line for a second specific time, and when the signal amplitude strength on the signal line is detected as larger than a specific value in the second specific time, a restoring signal is transmitted to trigger the microcontroller for restoring the action of the telephone set transmitting the voice signal received from outside to the signal line.
